(19) United States
(12) Patent Application Publication
(10) Pub. No.: US 2025/0337526 A1
(43) Pub. Date: Oct. 30, 2025

(54) Reconfigurable Galois Field Forward Error Correction Decoder For Optical Inter-Satellite Communication

(71) Applicant: The Regents of the University of Michigan, Ann Arbor, MI (US)

(72) Inventors: Xiangdong WEI, Ann Arbor, MI (US); Yufan Yue, Ann Arbor, MI (US); David Blaauw, Ann Arbor, MI (US); Hun-Seok KIM, Ann Arbor, MI (US)

(73) Assignee: The Regents of the University of Michigan, Ann Arbor, MI (US)

(21) Appl. No.: 19/192,524

(22) Filed: Apr. 29, 2025

Related U.S. Application Data
(60) Provisional application No. 63/640,262, filed on Apr. 30, 2024.

(51) Int. Cl. H04L 1/00; H04B 7/185

(52) U.S. Cl. CPC H04L 1/0071; H04B 7/18521

(57) ABSTRACT

A high-throughput forward error correction (FEC) decoder capable of decoding BCH, RS, Staircase and oFEC codes presented. With a flexible/reconfigurable BCH/RS inner code, it enables adaptive and reliable intersatellite optical communication. The decoder features unprecedented configurability in terms of Galois field (GF) size, code rate, iteration number, and parallel factor, providing a tradeoff between error correction performance, energy, and throughput. Implemented in 12 nm CMOS, the decoder in oFEC mode achieves a throughput of 33.06 Gb/s, an efficiency of 40.35 pJ/b, and a net coding gain of 7.27 dB at 10-6 BER with an inner code BCH (255,223), marking a 1.37-5.2× in throughput and 0.71-2.6 dB gain over prior work.

### GOVERNMENT CLAUSE

This invention was made with government support under HR0011-22-9-0043 awarded by the Defense Advanced Research Projects Agency. The government has certain rights in the invention.

### FIELD

The present disclosure relates to a reconfigurable decoder for optical inter-satellite communication.

### BACKGROUND

Optical wireless inter-satellite communication (OWC) is expected to fulfill the increasing needs of global highspeed internet. With a highly directional laser, it enables much higher bandwidth (data rate) compared to conventional radio frequency. However, a reliable and spectrally-efficient transmission cannot be established without mitigating noise from atmospheric and stellar sources. Another challenge is that existing satellite groups use different FEC schemes and are not interoperable.

Forward error correction (FEC) uses redundant parity bits to correct errors. Hard decision decoding (HDD) makes a firm decision on each received symbol and is more favored because it can achieve the high throughput required by OWC. To compensate for the lower error correcting capability of hard decision decoding (HDD), inner-outer concatenated/Zipper codes, such as Open Forward Error Correction (oFEC) and Staircase Code, are typically used in optical wireless inter-satellite communication. To build a versatile and adaptive OWC network, HDD decoders must support high throughput, high coding gain and arbitrary configurability. This requirement poses challenges as previous ASICs are optimized for single code structure and either limited throughput or limited correction performance.

This section provides background information related to the present disclosure which is not necessarily prior art.

### SUMMARY

This section provides a general summary of the disclosure, and is not a comprehensive disclosure of its full scope or all of its features.

In one aspect, a reconfigurable decoder is presented for optical inter-satellite communication. The decoder includes: an input loader, a set of decoders and an interleaver. The input loader is configured to receive a bitstream comprised of a plurality of codewords and loads bits from the bitstream into the input buffer, where each codeword is comprised of N bits encoded in accordance with an error correction code and arranged in accordance with an Open Forward Error Correction method or Staircase Code method. The set of decoders are configured to receive data from the input buffer, each decoder in the set of decoders receives a given row of bits from the input buffer, decodes the bits in the given row and stores decoded bits for the given row in an intermediary buffer, such that values in a front half of each row in the intermediary buffer are initialized and subsequently used to store a set of virtual bits, and values in a back half of each row in the intermediary buffer are populated with the decoded bits in sequence and referred to as a set of real bits. The interleaver is configured to receive decoded bits for the given row from the set of decoders and update corresponding locations in the set of virtual bits with values of the decoded bits from back half of the given row in accordance with the Open Forward Correction method or Staircase Code method while concurrently updating corresponding locations in the set of real bits with values of decoded bits from front half of the given row in accordance with the Open Forward Correction method or Staircase Code method.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram depicting an architecture for a reconfigurable decoder.

FIG. 2A is a diagram illustrating the decoding procedure in accordance with the Open Forward Correction standard, where the top of the figure shows the stages of the BCH/RS decoding procedure.

FIG. 2B is a diagram illustrating the decoding procedure in accordance with the Staircase Code standard, where the top of the figure shows the stages of the BCH/RS decoding procedure.

FIG. 3A is a diagram illustrating an improved decoding procedure that complies with the Open Forward Correction standard.

FIG. 3B is a diagram illustrating an improved decoding procedure that complies with the Staircase Code standard.

FIG. 3C is a diagram showing how virtual bits are separated from real bits and sub-blocks are accessed with word-level row addressing.

FIG. 3D is a diagram illustrating how variants of Open Forward Correction Codes and Staircase Codes can be supported by flexible inner Bose-Chaudhuri-Hocquenghem (BCH) code or Reed-Solomon decoding and interleaving.

FIG. 4A is a diagram depicting a compact arrangement for the interleaver in accordance with the Open Forward Correction method.

FIG. 4B is a diagram further depicting the real bit to virtual bit mapping procedure employed by the interleaver in the Open Forward Correction mode.

FIG. 4C is a diagram depicting an arrangement for the interleaver in accordance with the Staircase Codes method.

FIG. 4D is a diagram further depicting the real bit to virtual bit mapping procedure employed by the interleaver in Staircase Code mode.

FIG. 5 is a diagram further depicting an example implementation of a BCH/RS decoder.

FIG. 6 is a diagram further depicting the processing elements in a datapath of the BCH/RS decoder.

FIG. 7 illustrates a reconfigurable GF multiplier architecture.

Corresponding reference numerals indicate corresponding parts throughout the several views of the drawings.

### DETAILED DESCRIPTION

Example embodiments will now be described more fully with reference to the accompanying drawings.

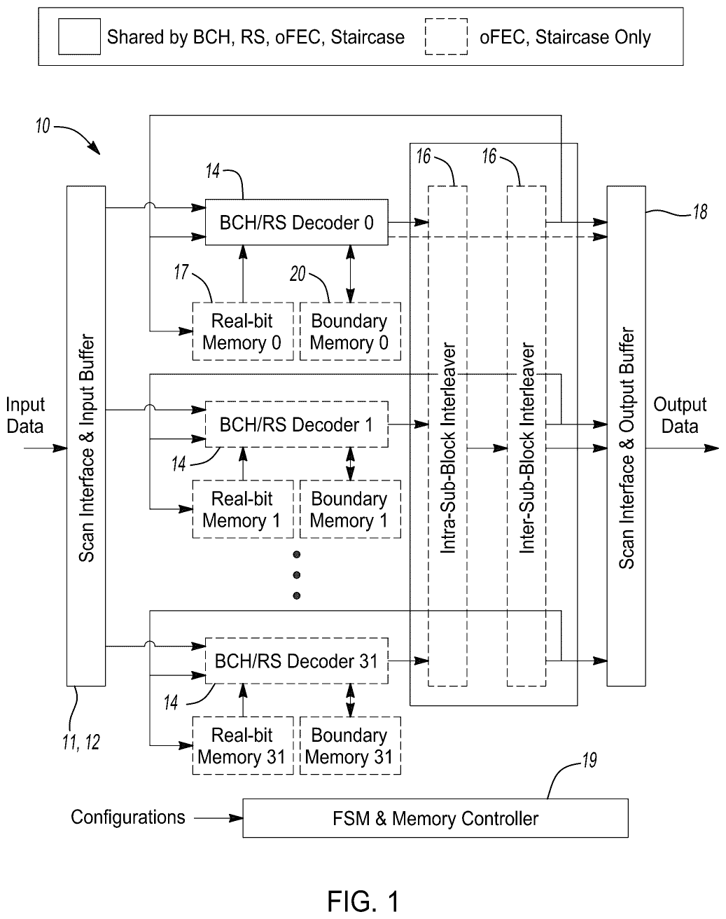

FIG. 1 depicts an architecture for a reconfigurable decoder 10. The reconfigurable decoder 10 is comprised of an input loader 11, an input buffer 12, a set of decoders 14, an interleaver 16, an intermediary buffer 17, an output buffer 18, a controller 19 and a boundary buffer 20. Each of these components is further described below.

The input loader 11 is configured to receive a bitstream comprised of a plurality of codewords and loads bits from the bitstream into the input buffer 12, where each codeword is comprised of N bits encoded in accordance with an error correction code and arranged in accordance with either an Open Forward Error Correction method or a Staircase Code method. In one example, the error correction code is further defined as a Bose-Chaudhuri-Hocquenghem (BCH) code or Reed-Solomon (RS) code although other types of error correction codes are contemplated by this disclosure. Further details about the Open Forward Error Correction (oFEC) standard can be found in the Open ROADM MSA Device white paper, 5.0 W-Port Digital Specification 2021 which is incorporate herein in its entirety. Further details about the Staircase Code standard can be found in an article entitled “Staircase Codes: FEC for 100 Gb/s OTN” in the Journal of Lightwave Technology (January 2012) which is incorporate herein in its entirety. It is envisioned that other types of forward error correction methods can also be accommodated by the reconfigurable decoder 10.

The set of decoders 14 are configured to receive data from the input buffer 12. In an example embodiment, the set of decoders 14 process individual rows of the input buffer row by row starting at top of the input buffer and moving downward in the input buffer. Each decoder in the set of decoders 14 receives a given row of bits from the input buffer 12, decodes the bits in the given row and stores decoded bits for the given row in an intermediary buffer, such that values in a front half of each row in the intermediary buffer 17 are initialized and subsequently used to store a set of virtual bits, and values in a back half of each row in the intermediary buffer 17 are populated with the decoded bits in sequence and referred to as a set of real bits;

In the example embodiment, the interleaver 16 is configured to receive decoded bits for the given row from the set of decoders and update corresponding locations in the set of virtual bits with values of the decoded bits from back half of the given row in accordance with either the Open Forward Correction method or the Staircase Code method while concurrently updating corresponding locations in the set of real bits with values of decoded bits from front half of the given row in accordance with the Open Forward Correction method or the Staircase Code method.

In accordance with the Open Forward Correction method, the intermediary buffer is arranged into an R×C array of blocks, such that each block is comprised of B×B bits, R is a number of a block row, each block row contains N/B blocks, and C is a number of a block column. For updating, corresponding location of kth bit of a codeword in the set of virtual bits is given by

$$\{ ( R \hat{} 1 ) - 2 G - 2 N / B + 2 [ k / B ] , [ k / B ] , ( k \% B ) \hat{} r , r \} for k < N$$

$$\{ R , [ ( k - N ) / B ] , r , ( k \% B ) r \} for k >= N$$

where [.] denotes the floor operator, (a % b) denotes the value of a modulo b, and (a\hat{ }b) represents the number with a binary representation equal to bitwise exclusive OR of binary representation of the number a and b.

In accordance with the Staircase Code method, the intermediary buffer shares the same structure with the Open Forward Correction method but different interleaving and updating pattern. For the Staircase Code method, updating corresponding location of kth bit of a codeword in the set of virtual bits is given by

$$\{ R - R \% C - C + [ k / B ] , R \% C , ( k \% B ) , r \} for k < N$$

$$\{ R , [ ( k - N ) / B ] , r , ( k \% B ) \} for k >= N$$

where [.] denotes the floor operator, (a % b) denotes the value of a modulo b.

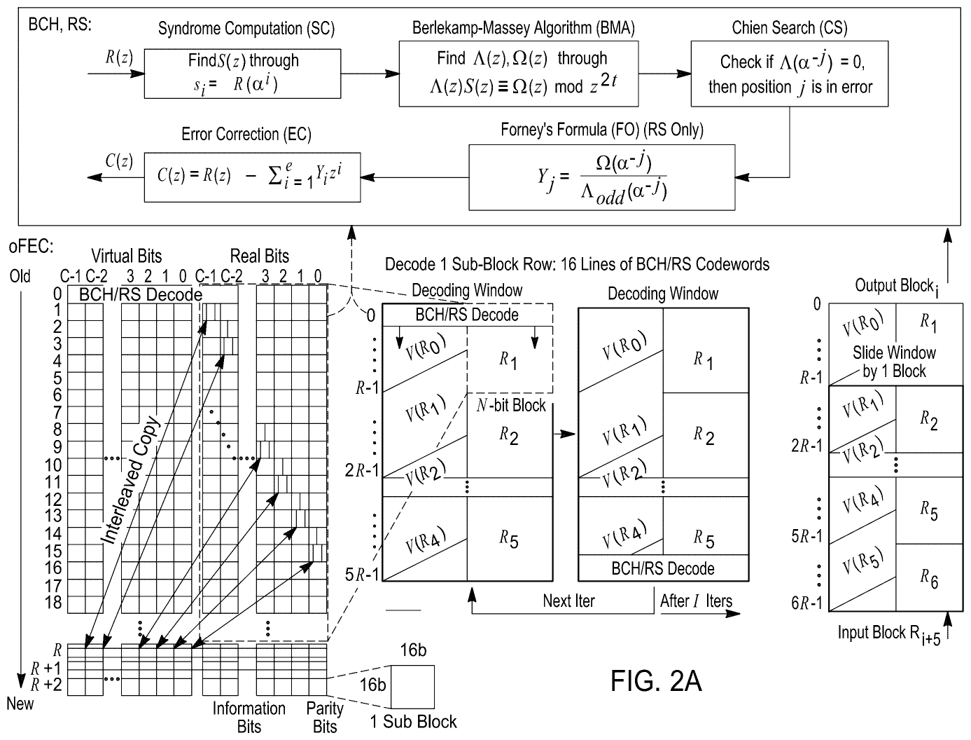

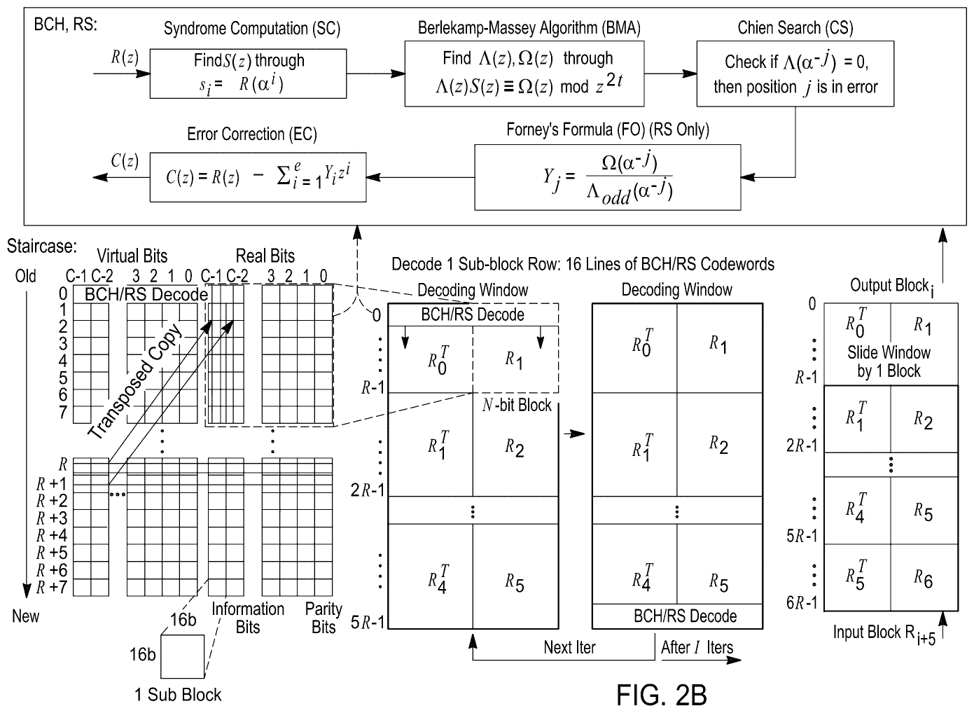

FIG. 2A further illustrates the decoding procedure in accordance with the Open Forward Correction method. oFEC code consists of a block of R×C sub-blocks while each sub-block contains 16×16 bits. These are called real bits containing the information bits and parity bits, and these bits are transmitted row by row from C columns of sub-blocks. Previously transmitted real bits are copied and interleaved to form C columns of virtual bits based on the rule that virtual bits (rb, cb) inside a sub-block (rB, cB) is mapped from real bits (rb⊕cb, rb) of a sub-block (rB⊕1−2G−2−2cB, cB), where G is a configurable parameter defined by 2G=R−2C. As shown on the bottom left, virtual and real bits are concatenated horizontally in the decoder so that one sub-block row of 2C sub-blocks is decoded as 16 rows of BCH or RS codewords. The decoder applies a window containing 2W blocks, decoding WR sub-block rows from top to bottom with inner BCH/RS decoders in multiple iterations. Upon reaching the iteration limit, the window slides down by R sub-block rows, outputting real bits in the completed top (oldest) block and accepting a new real-bit block input at the bottom.

Alternatively, FIG. 2B further illustrates the decoding procedure in accordance with the Staircase Code method. Staircase code consists of a block of R×C sub-blocks while each sub-block contains 16×16 bits. These are called real bits containing the information bits and parity bits, and these bits are transmitted row by row from C columns of sub-blocks. Previously transmitted real bits are copied and transposed to form C columns of virtual bits based on the rule that virtual bits (rb, cb) inside a sub-block (rB, cB) is mapped from real bits (cb, rb) of a sub-block (rB−rB % C−C+cB, [rB % C]). As shown on the bottom left, virtual and real bits are concatenated horizontally in the decoder so that one sub-block row of 2C sub-blocks is decoded as 16 rows of BCH or RS codewords. The decoder applies a window containing 2W blocks, decoding WR sub-block rows from top to bottom with inner BCH/RS decoders in multiple iterations. Upon reaching the iteration limit, the window slides down by R sub-block rows, outputting real bits in the completed top (oldest) block and accepting a new real-bit block input at the bottom.

During decoding, it is crucial that the real bits and corresponding virtual bits maintain the identical value. If a real bit is corrected by the inner BCH/RS decoder, its corresponding virtual bit should also be updated, and vice versa. For oFEC/Staircase iterative decoding, it is possible to store real bits only since virtual bits are copies of real bits from different rows. However, such designs will require accessing the memory both in the vertical/column order for virtual bits and the horizontal/row order for real bits. Accessing one component codeword in the memory uses different addresses for the front and back bits in the same cycle, posing a challenge to implement conflict-free multiple accesses at the bit level (not word level) with multiple memory banks. A 2-D register array proposed in prior designs can be a solution to allow arbitrary bit-level accesses in both vertical and horizontal orders at the cost of excessive area, power consumption, and a complex routing network to select registers' input/output.

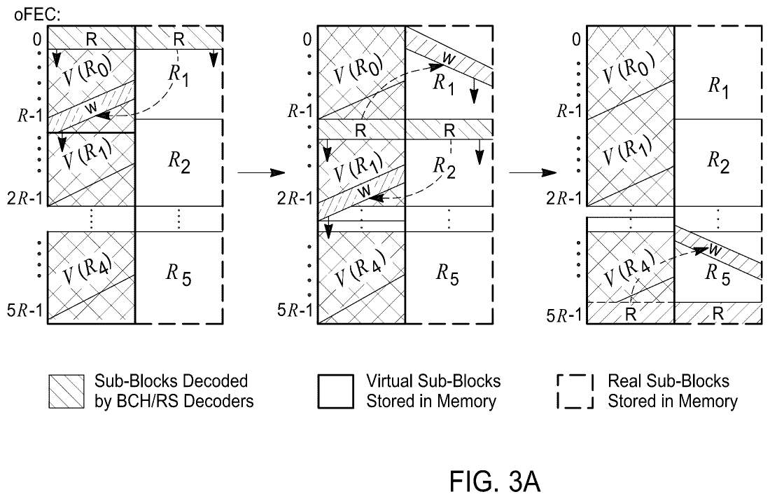

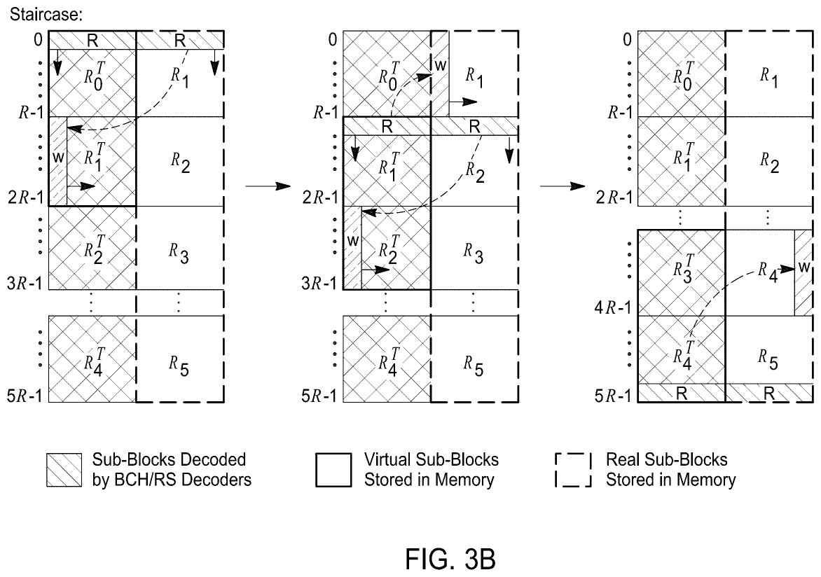

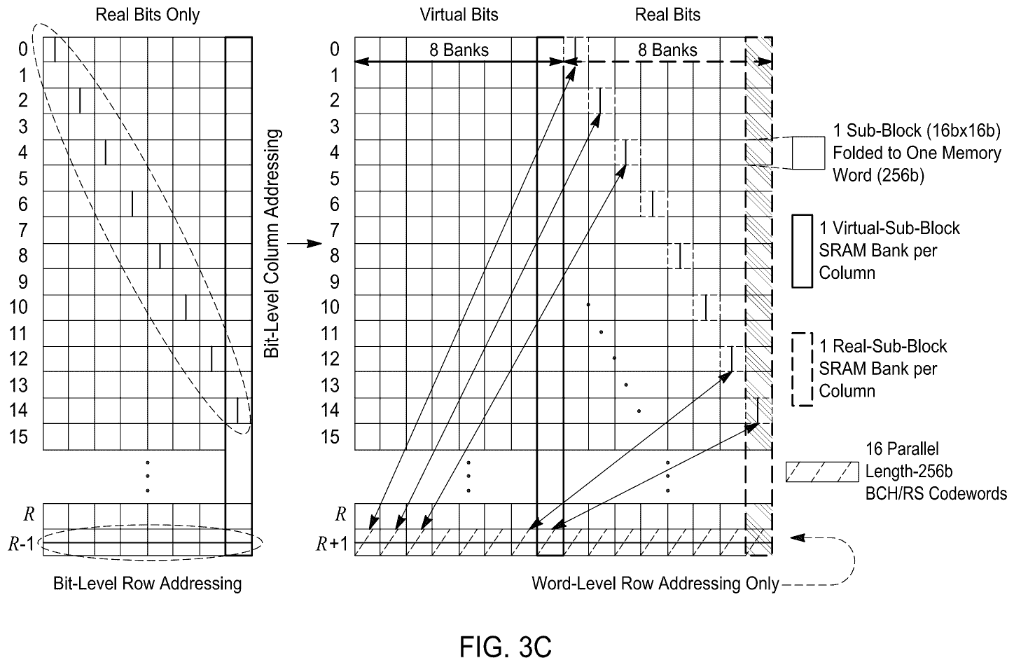

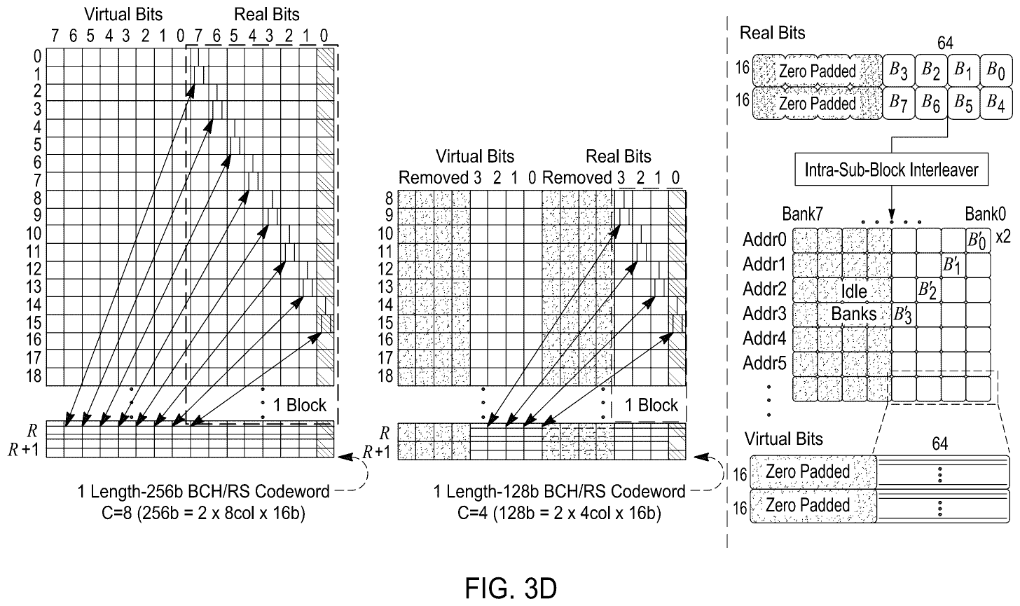

This disclosure instead separates virtual bits from real bits and folds one sub-block into one memory word to implement memory with SRAMs and access them at the word (sub-block) level without access conflicts as shown on the right side of FIG. 3C. To further improve the area and energy efficiency, a back-to-back inner decoding and bidirectional bit mapping scheme is proposed as shown in FIGS. 3A and 3B for oFEC and Staircase decoding, respectively. When the inner decoder completes a row, it updates the subsequent virtual bits with the decoded real bits, and at the same time, it overwrites the original real bits with the decoded virtual bits with on-the-fly transposition/permutation. This back-to-back bidirectional scheme eliminates the idle period, and it reduces the read and write accesses of each real/virtual bit to only 1 time because the decoded bits are immediately interleaved and stored in the desired bit location and form without intermediate storage. Further, this scheme minimizes the virtual-bit buffer size for oFEC to match R×C sub-blocks since the virtual bits are consumed early in the cycle. The virtual-bit memory is 20% of the real-bit memory size for a 5-block window and will only be smaller as the real-bit memory utilization increases proportionally with the window size. The virtual-bit buffer size for Staircase is 2×R×C sub-blocks but the values of R is much smaller than oFEC so the memory can be reused. The size overhead is hidden by the area, power, and design complexity gain of using compact SRAMs instead of registers to implement memory.

In addition to oFEC and Staircase codes, the reconfigurable decoder 10 supports BCH and/or Reed-Solomon error correction as a standalone code. With reference to top of FIGS. 2A and 2B, BCH consists of four stages: syndrome computation (SC), the Berlekamp-Massey algorithm (BMA), Chien search (CS), and error correction (EC). All operations are over the Galois field GF(2m), where m is the GF size. A (n, k, t) codeword has n symbols, including k information symbols, and can correct up to t errors. While BCH codes have a binary symbol, RS codes have m bits per symbol and require an additional stage to calculate the error value using the Forney algorithm (FO).

Returning to FIG. 1, the reconfigurable decoder 10 is configurable to operate in an oFEC mode, a Staircase mode, and a BCH/RS mode. In an oFEC or Staircase mode, each decoder in the set of decoders simultaneously decode bits of inner codewords (e.g., 32). Their outputs are interleaved to either update virtual bits that are later fed back into BCH/RS decoders, or retrieve and store real bits in the 32 real-bit memory banks for the next iteration. 32 boundary memory banks 20 store the topmost C (R−C+1)/CR virtual sub-blocks of the current window whose original real bits have been outputted in the previous window. The real bits and (boundary) virtual bits to be decoded by ith BCH/RS decoder are stored locally in the ith memory bank to reduce wiring distance. In BCH/RS only mode, the outer code interleaver is clock gated and only one BCH/RS decoder is activated to match the top-level IO bandwidth. The design can switch between different modes in ˜10 cycles, and supports back-to-back decoding of different codes.

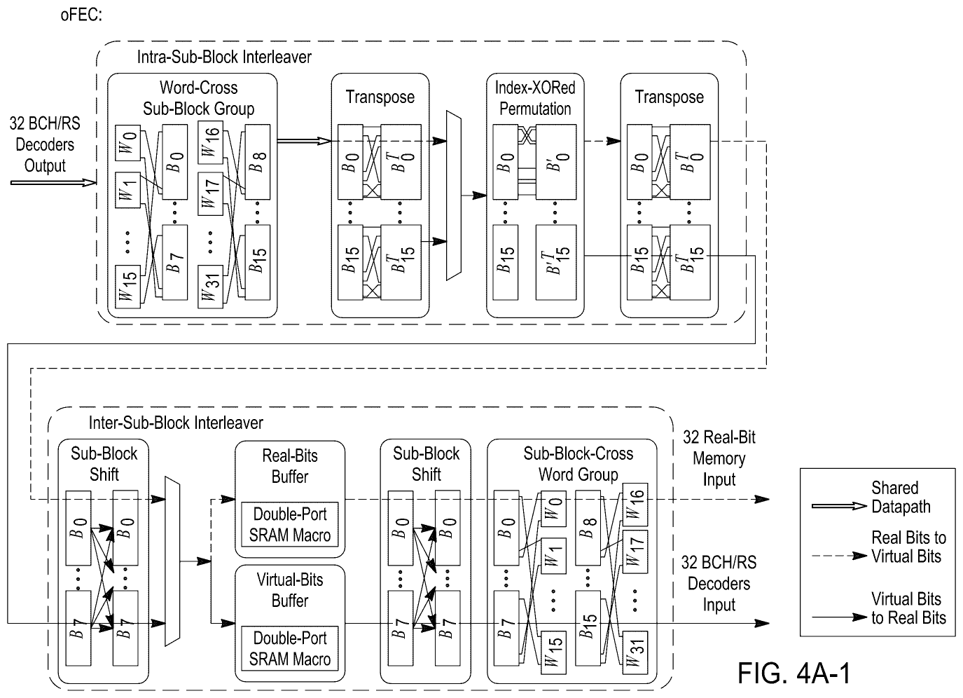

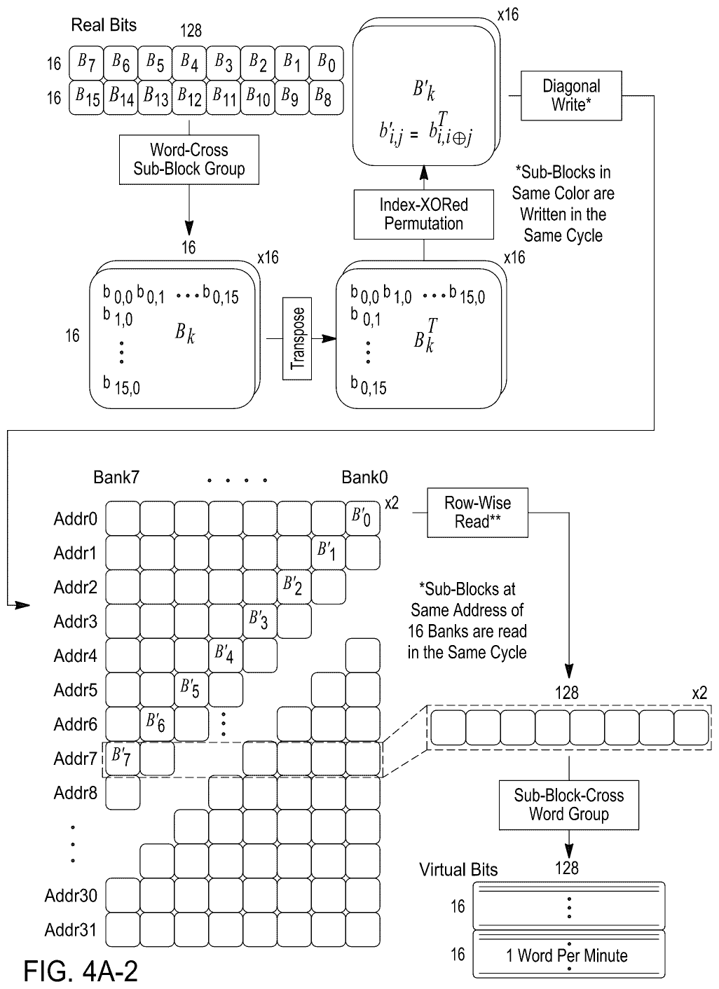

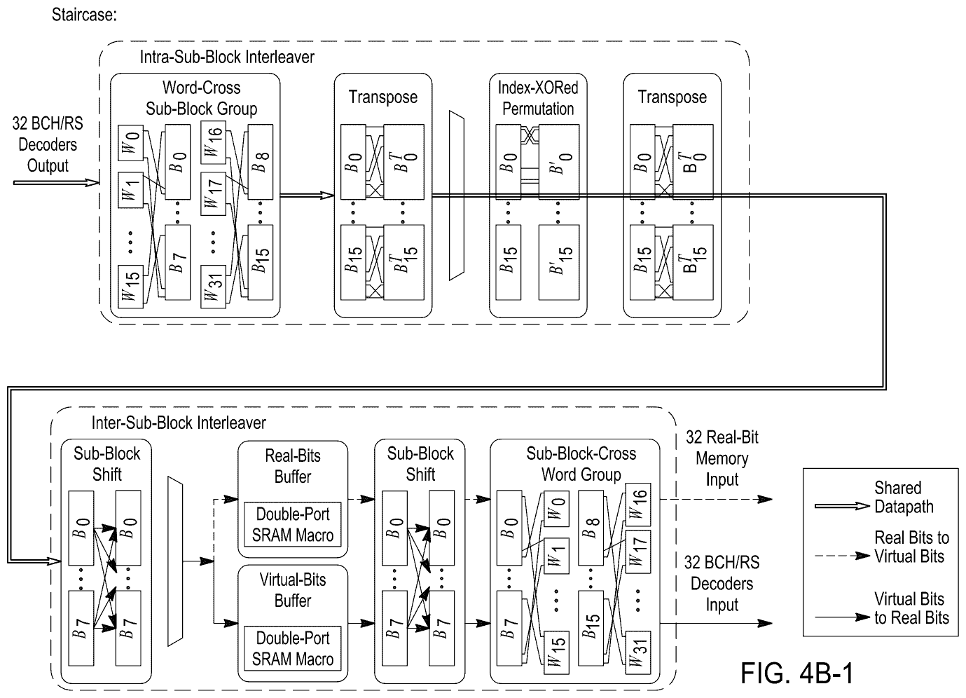

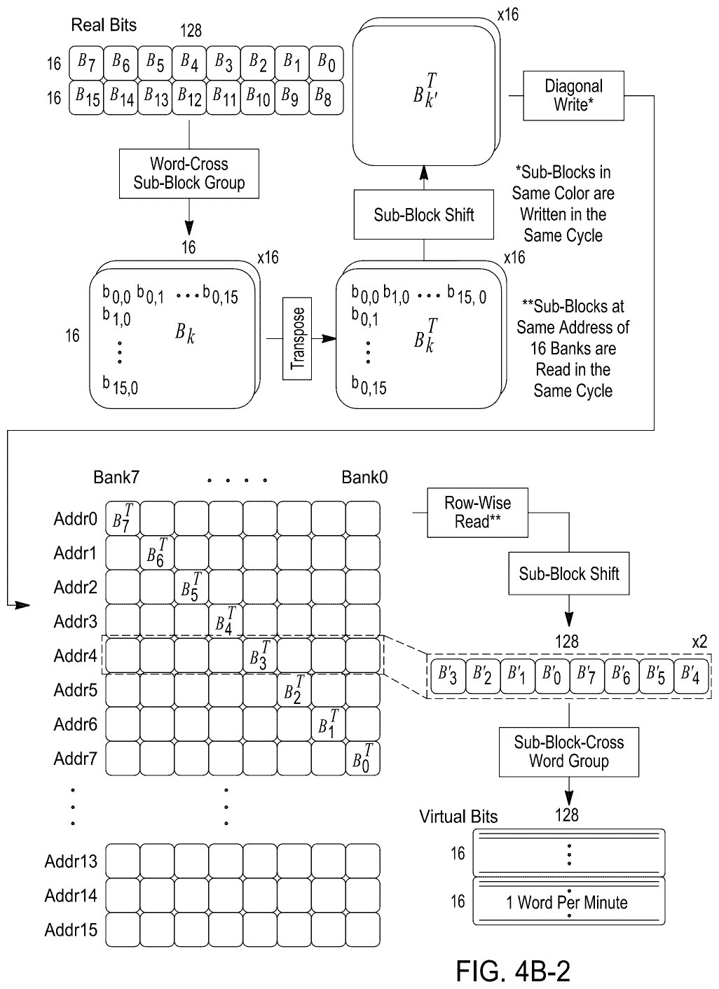

oFEC decoding requires low-latency mapping between real bits and virtual bits to prevent the inner decoders from starving. Intra-block and inter-block interleavers perform bidirectional mapping with high parallelism and low area overhead using the proposed real-bit to virtual-bit mapping shown in FIGS. 4A and 4B. In the intra-sub-block interleaver, the 32 inner decoder outputs are fed in every cycle and first grouped into 16 16b×16b sub-blocks. Then, all sub-blocks are transposed and permuted in row-wise index-XORed fashion. Two sets of 8 sub-blocks are written to multi-bank buffers in the intersub-block interleaver using counter-diagonal addressing. Subblocks at the same address of all 16 banks are read out in parallel and reassembled to 32 128b words. The multi-bank buffer size is minimized by cyclically overwriting old data.

The opposite mapping (virtual to real) is identical except the order of transpose and index-XORed permutation are swapped, and writing buffers in inter-sub-block interleavers use main diagonal addressing. Sub-block regrouping and permutation units are shared between the two time-interleaved mapping directions. All interleaver operations execute at the sub-block level and shorter inner codewords are supported by zero filling empty sub-blocks and turning off unused memory banks as shown in the right of FIG. 3D.

The intra-block and inter-block interleavers can be easily reconfigured to perform mapping between real bits and virtual bits in accordance with Staircase Code Standard as shown in FIGS. 4C and 4D. In the intra-sub-block interleaver, the 32 inner decoder outputs are fed in every cycle and first grouped into 16 16b×16b sub-blocks. Then, all sub-blocks are transposed. Two sets of 8 sub-blocks are reordered and shifted to the correct sequence based on the bank order of the multi-bank buffer into which they will be written to using main-diagonal addressing. The shifting amount is different every cycle and iterate over C cycles. Each bank of the intermediary buffer has a different starting writing address and cycles over address ranges in increments of C. Subblocks at the same address of all 16 banks are read out in parallel, reordered to the sequence they will be decoded, and reassembled to 32 128b words. The opposite mapping (virtual to real) is identical except that sub-blocks are buffered in a separate real-bits memory.

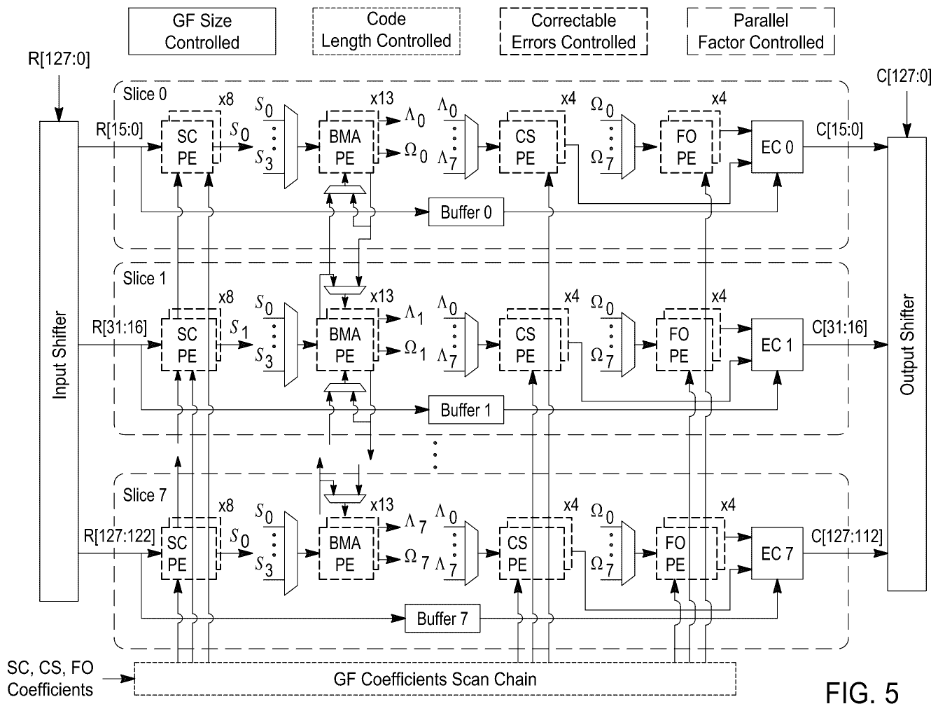

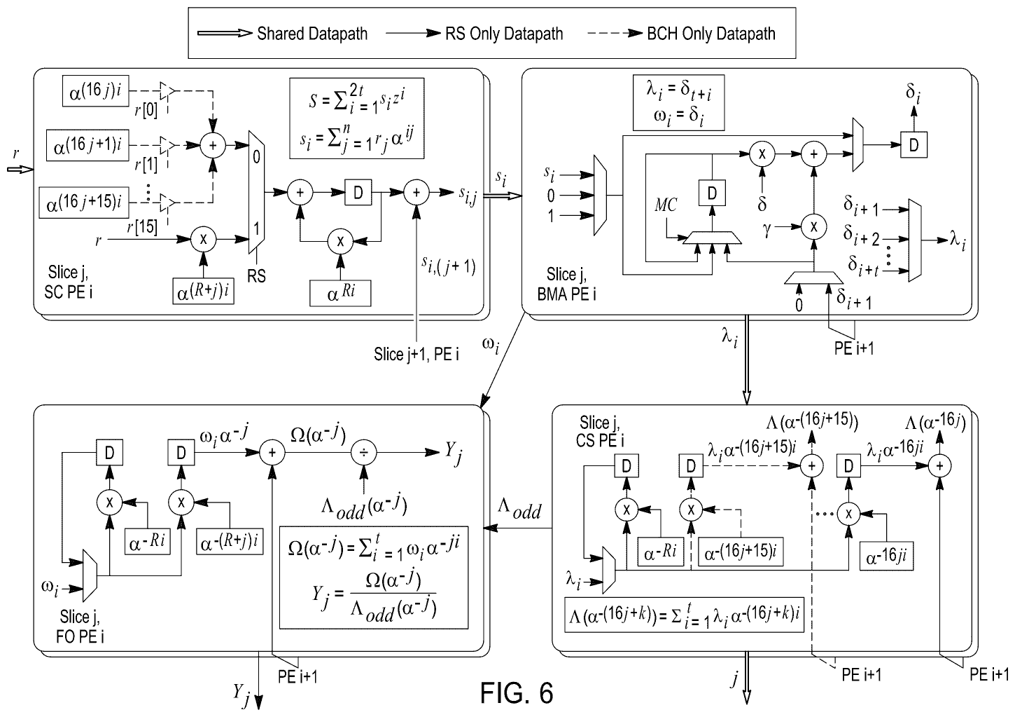

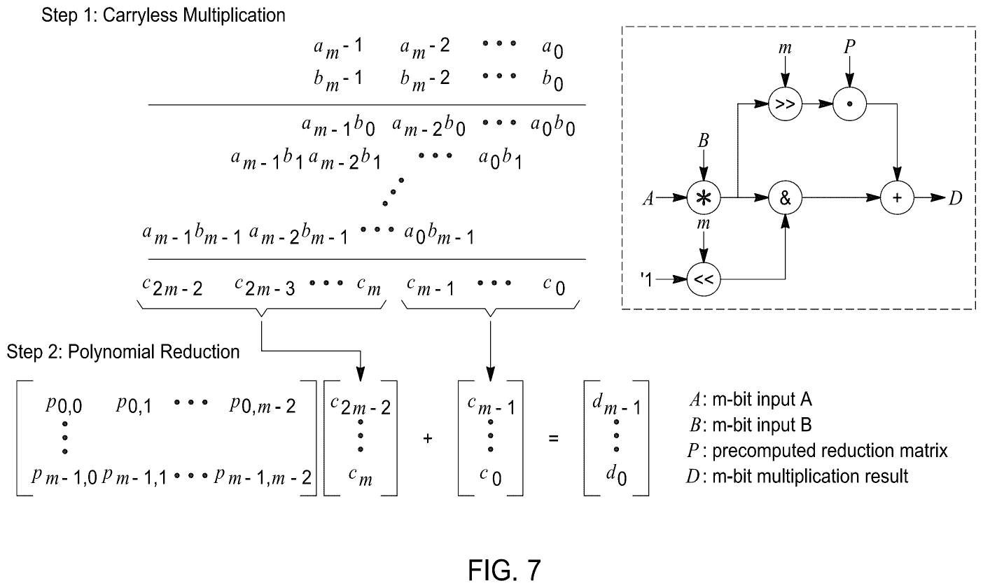

In the example embodiment, the reconfigurable decoder 10 consists of 8 slices with each slice functioning as a 16-symbol parallel BCH decoder or a single-symbol RS decoder as seen in FIG. 5. FIGS. 5 and 6 shows the reconfiguration structure to support flexible code parameters (each is assigned a different color) enabling arbitrary code combinations with minimal overhead. Reconfiguration of the interconnect between the BMA PEs allows variable selection of the correctable errors. The reconfigurable GF multiplier in FIG. 7 supports variable GF size by performing a carryless multiplication followed by a multiplication with a reconfigurable reduction matrix. Finally, slices and PEs are clock-gated according to the selected parallel factor and correctable errors which ensures high resource utilization for a specific standard. The decoder stops early when all computed syndromes are zero.

While the reconfigurable decoder 10 can maximize throughput by operating 8 slices in parallel independently, it also supports grouping multiple slices to form larger composite slices, trade-offing throughput for error-correction capability. The 8 slices can be configured as four 2-slice groups, two 4-slice groups, or a single 8-slice group. The white multiplexers surrounding the processing elements (PEs) and the flexible interconnects crossing slice boundaries in FIG. 5 function as glue logic, enabling correct data transfer between slices. The PEs are reused across configurations, resulting in minimal area overhead.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A reconfigurable decoder for optical inter-satellite communication, comprising:
an input loader configured to receive a bitstream comprised of a plurality of codewords and loads bits from the bitstream into the input buffer, where each codeword is comprised of N bits encoded in accordance with an error correction code and arranged in accordance with an Open Forward Error Correction method or Staircase Code method;
a set of decoders are configured to receive data from the input buffer, each decoder in the set of decoders receives a given row of bits from the input buffer, decodes the bits in the given row and stores decoded bits for the given row in an intermediary buffer, such that values in a front half of each row in the intermediary buffer are initialized and subsequently used to store a set of virtual bits, and values in a back half of each row in the intermediary buffer are populated with the decoded bits in sequence and referred to as a set of real bits; and
an interleaver configured to receive decoded bits for the given row from the set of decoders and update corresponding locations in the set of virtual bits with values of the decoded bits from back half of the given row in accordance with the Open Forward Correction method or Staircase Code method while concurrently updating corresponding locations in the set of real bits with values of decoded bits from front half of the given row in accordance with the Open Forward Correction method or Staircase Code method.

2. The reconfigurable decoder of claim 1 wherein the set of decoders process individual rows of the input buffer row by row starting at top of the input buffer and moving downward in the input buffer.

3. The reconfigurable decoder of claim 1 wherein the error correction code is further defined as one of a Bose-Chaudhuri-Hocquenghem (BCH) code or a Reed-Solomon (RS) code.

4. The reconfigurable decoder of claim 1 wherein the intermediary buffer is arranged into an R×C array of blocks, such that each block is comprised of B×B bits, R is a number of a block row, each block row contains N/B blocks, and C is a number of a block column; and wherein corresponding location of kth bit of a codeword in the set of virtual bits for Open Forward Correction method is given by
$$\{ ( R \hat{} 1 ) - 2 G - 2 N / B + 2 [ k / B ] , [ k / B ] , ( k \% B ) \hat{} r , r \} for k < N$$
$$\{ R , [ ( k - N ) / B ] , r , ( k \% B ) \hat{} r \} for k >= N$$
where [.] denotes the floor operator, (a % b) denotes the value of a modulo b, and (a\hat{ }b) represents the number with a binary representation equal to bitwise exclusive OR of binary representation of the number a and b.

5. The reconfigurable decoder of claim 1 wherein the intermediary buffer is arranged into an R×C array of blocks, such that each block is comprised of B×B bits, R is a number of a block row, each block row contains N/B blocks, and C is a number of a block column; and wherein corresponding location of kth bit of a codeword in the set of virtual bits for Staircase Code method is given by
$$\{ R - R \% C - C + [ k / B ] , R \% C , ( k \% B ) , r \} for k < N$$
$$\{ R , [ ( k - N ) / B ] , r , ( k \% B ) \} for k >= N$$
where [.] denotes the floor operator, (a % b) denotes the value of a modulo b.

6. The reconfigurable decoder of claim 1 is configurable to operate in an oFEC mode, a Staircase mode, and a BCH/RS mode, such that each decoder in the set of decoders operates simultaneously to decode bits in the oFEC/Staircase mode and only one decoder operates to decode bits in the BCH/RS mode.

7. The reconfigurable decoder of claim 6 wherein the interleaver is disabled during the BCH/RS mode.

8. The reconfigurable decoder of claim 1 wherein each decoder in the set of decoders contains a plurality of datapaths arranged in parallel, such that each datapath can process bits from the bitstream concurrently and datapaths can be grouped together with flexible interconnects to further extend the error correction capability beyond one datapath.

9. The reconfigurable decoder of claim 1 wherein each datapath in the plurality of datapaths of a given decoder includes an SC processing element, an BMA processing element, an CS processing element and an FO processing element, where the SC processing element implements a syndrome computation, the BMA processing element implements a Berlekamp-Massey method, the CS processing element implements a Chien search, and the FO processing element implements a Forney method.

10. The reconfigurable decoder of claim 9 wherein at least of the SC processing element, an BMA processing element, an CS processing element and an FO processing element includes a Galois field multiplier, where size of the Galois field and a precomputed reduction matrix of the Galois field multiplier are configurable.

11. The reconfigurable decoder of claim 9 each decoder in the set of decoders includes a set of BMA processing elements interconnected to each other by a multiplexer, such that selection of a subset of the BMA processing elements to implement the Berlekamp-Massey method determines a number of correctable errors in each symbol.

12. A computer-implemented method for decoding a bitstream, comprising:
receiving a bitstream comprised of a plurality of codewords, where each codeword is comprised of N bits encoded in accordance with an error correction code and arranged in accordance with an Open Forward Error Correction method or Staircase Code method;
processing individual rows of the input buffer by decoding the bits in a given row and storing values of decoded bits of the given row in an intermediary buffer, such that values in a front half of each row in the intermediary buffer are initialized and subsequently used to store a set of virtual bits, and values in a back half of each row in the intermediary buffer are populated with the decoded bits in sequence and referred to as a set of real bits;
interleaving decoded bits by updating corresponding locations in the set of virtual bits with values of the decoded bits from back half of the given row in accordance with the Open Forward Correction method or Staircase Code method, while concurrently updating corresponding locations in the set of real bits with values of decoded bits from front half of the given row in accordance with the Open Forward Correction method or Staircase Code method; and
outputting values of the decoded bits in the back half of the rows in an output buffer.

13. The method of claim 12 further comprises processing individual rows of the input buffer row by row starting at top of the input buffer and moving downward in the input buffer.

14. The method of claim 12 wherein the 2N-bit error correction code of each row is further defined as one of a Bose-Chaudhuri-Hocquenghem (BCH) code or a Reed-Solomon (RS) code

15. The method of claim 12 wherein the intermediary buffer is arranged into an R×C array of blocks, such that each block is comprised of B×B bits, R is a number of a block row, each block row contains N/B blocks, and C is a number of a block column; and wherein corresponding location of kth bit of a codeword in the set of virtual bits for Open Forward Correction method is given by
$$\{ ( R \hat{} 1 ) - 2 G - 2 N / B + 2 [ k / B ] , [ k / B ] , ( k \% B ) \hat{} r , r \} for k < N$$
$$\{ R , [ ( k - N ) / B ] , r , ( k \% B ) \hat{} r \} for k >= N$$
where [.] denotes the floor operator, (a % b) denotes the value of a modulo b, and (a\hat{ }b) represents the number with a binary representation equal to bitwise exclusive OR of binary representation of the number a and b.

16. The method of claim 12 wherein the intermediary buffer is arranged into an R×C array of blocks, such that each block is comprised of B×B bits, R is a number of a block row, each block row contains N/B blocks, and C is a number of a block column; and wherein corresponding location of kth bit of a codeword in the set of virtual bits for Staircase Code method is given by
$$\{ R - R \% C - C + [ k / B ] , R \% C , ( k \% B ) , r \} for k < N$$
$$\{ R , [ ( k - N ) / B ] , r , ( k \% B ) \} for k >= N$$
where [.] denotes the floor operator, (a % b) denotes the value of a modulo b.

17. The method of claim 14 wherein interleaving decoded bits for Open Forward Correction method further comprise
receiving decoded bits for a given codeword output by each decoder in the set of decoders;
stacking decoded bits from each decoder in the set of decoders to form an incoming matrix;
regrouping the decoded bits in the incoming matrix into a set of sub-blocks,
transposing values of each sub-block in the set of sub-blocks to yield a set of transposed blocks;
applying an index-XOR operation to each sub-block in the set of transposed blocks to yield a set of permutated blocks, where for each row of a given transposed block, elements of the row are permutated based on their column index by the index-XOR operation;
writing each block in the set of permutated block to an intermediary buffer in accordance with the Open Forward Correction method;
reading out each block row of the intermediary buffer in parallel and stacking the block rows from the intermediary buffer to form an outgoing matrix;
rearranging bits of the outgoing matrix to obtain a plurality of codewords; and
storing the plurality of codewords in memory or directly passing to the set of decoders.

18. The method of claim 15 wherein interleaving decoded bits for Staircase Codes method further comprise
receiving decoded bits for a given codeword output by each decoder in the set of decoders;
stacking decoded bits from each decoder in the set of decoders to form an incoming matrix;
regrouping the decoded bits in the incoming matrix into a set of sub-blocks,
transposing values of each sub-block in the set of sub-blocks to yield a set of transposed blocks;
reorder the sub-blocks from their decoded sequence to the correct sequence based on the bank order of the intermediary buffer into which they will be written;
writing each block in the set of permutated block to an intermediary buffer in accordance with the Staircase Code method, where each bank of the intermediary buffer has a different starting address and cycles over address ranges in increments of C;
reading out each block row of the intermediary buffer in parallel and stacking the block rows from the intermediary buffer to form an outgoing matrix;
reorder the sub-blocks from the bank order of the intermediary buffer they are read from to match the sequence required for decoding;
rearranging bits of the outgoing matrix to obtain a plurality of codewords; and
storing the plurality of codewords in memory or directly passing to the set of decoders.

19. The method of claim 12 further comprises
a) dividing the input buffer into multiple processing slices, where each processing slice includes a set number of block rows from the input buffer;
b) defining a decoding window that encompasses a predefined number of processing slices in the input buffer;
c) starting at top of the decoding window and moving downward,
processing rows for each of the processing slices in the decoding window row by row;
d) outputting values of decoded bits from a given processing slice at top of the decoding window;
e) repositioning the decoding window downward in the input buffer in a manner that excludes the given processing slice; and
f) repeating steps c)-f) until data in the input buffer is depleted.
